(19) United States
(12) Patent Application Publication
(10) Pub. No.: US 2023/0080827 A1
(43) Pub. Date: Mar. 16, 2023

(54) ADDITIVE MANUFACTURING SYSTEM WITH FLOW CONTROL AND ADDITIVE INJECTION DEVICE

(71) Applicant: TRIEX, LLC, BARRE, VT (US)

(72) Inventor: TYLER MCNANEY, BARRE, VT (US)

(73) Assignee: TRIEX, LLC, BARRE, VT (US)

(21) Appl. No.: 17/942,281

(22) Filed: Sep. 12, 2022

Related U.S. Application Data
(60) Provisional application No. 63/243,280, filed on Sep. 13, 2021.

(51) Int. Cl. B29C 64/336; B29C 64/295; B29C 64/209; B29C 64/118; B33Y 30/00; B33Y 10/00

(52) U.S. Cl. CPC B29C 64/336; B29C 64/295; B29C 64/209; B29C 64/118; B33Y 30/00; B33Y 10/00; B29K 2995/002

(57) ABSTRACT

A print head for an additive manufacturing system includes a print head having a nozzle configured to a flowable extrudate to form an object, and an additive injection device configured to add an additive to the flowable extrudate prior to exiting the nozzle.

### CROSS-REFERENCE TO RELATED APPLICATIONS

This application claims the benefit of U.S. Provisional Application Ser. No. 63/243,280, filed on Sep. 13, 2021, which is hereby incorporated by reference in its entirety.

### FIELD OF THE INVENTION

The present invention relates generally to additive manufacturing, and more particularly to an additive manufacturing system having a flow control mechanism and an additive manufacturing system having an additive injection device.

### BACKGROUND OF THE INVENTION

Additive manufacturing is a process of creating three-dimensional parts and structures from a CAD model or a digital 3D model by depositing overlapping layers of material under the guided control of a controller. Additive manufacturing can take many forms including, for example, fused deposition modeling (FDM) and fused particle fabrication (FPF). With FDM or FPF systems, a raw material is fed to an extrusion head or nozzle where it is heated and exits the nozzle as a flowable bead. Other systems, rather than heating the raw material at the extrusion head or nozzle, produce a flowable extrudate upstream from the nozzle, which is then conveyed to the nozzle via a melt tube. An example of such a system is disclosed in U.S. patent application Ser. No. 17/024,794, which is hereby incorporated by reference herein in its entirety.

Each of these types of additive manufacturing can suffer from what is known as stringing, drooling, or oozing when printing three-dimensional objects. This occurs when small strings of plastic or other print material are left behind on the 3D printed object. This is typically due to plastic oozing out of the nozzle while the extrusion head is moving to a new location. Where FDM systems, one solution to this problem is to retract the filament into the nozzle when stopping printing or moving the extrusion head to a new location. Notably, however, retraction is not possible with FPF systems, or where a flowable extrudate is supplied to the nozzle directly. Even with FDM systems, retraction may not solve the problem of stringing, entirely, particularly where moving the nozzle over large distances is required.

Existing additive manufacturing systems are also limited in terms of in-line variability of the print material utilized. In particular, while existing systems do allow various materials, compositions, and colors to be used, changing from one material to another, or from one color to another, typically involves either retracting a first filament (where a filament is used), or exhausting all of a first material, and then switching to a second material having different properties, composition or colors (e.g., by loading a material of a different color, composition, etc., or adding particles or granules of a different color, composition, etc.). This process can be tedious and can significantly increase print time, and can result in defects and blemishes in the finished object due to non-continuous formation of the article.

In view of the above, there is a need for an additive manufacturing system that overcomes some of the limitations of existing systems.

### SUMMARY OF THE INVENTION

In view of the foregoing, it is an object of the present invention to provide an additive manufacturing system.

It is an object of the present invention to provide an additive manufacturing system having an ON /OFF flow control mechanism.

It is another object of the present invention to provide an additive manufacturing system that allows for properties of the flowable extrudate to be varied in real-time as part of the in-line printing process.

These and other objects are achieved by the present invention.

According to an embodiment of the present invention, a system for additive manufacturing includes print head having a nozzle configured to output a flowable extrudate to form an article, and an additive injection device configured to add an additive to the flowable extrudate prior to exiting the nozzle.

According to another embodiment of the present invention, a method of additive manufacturing includes the steps of moving a print head and outputting a flowable print material according to set of instructions executed by a controller, to form an article, within the print head, mixing an additive with the flowable print material to alter a characteristic of the flowable print material.

According to yet another embodiment of the present invention, a system for additive manufacturing includes print head having a nozzle configured to output a print material to form an article, and a flow control valve configured to selectively control a flow of the print material from the nozzle, a control and positioning system configured to control movement of the print head according to a preprogrammed set of instructions, and an additive injection device configured to add an additive to the print material prior to exiting the nozzle to alter a characteristic of the print material, the additive injection device having a flow control valve configured to selectively control a flow of the additive into the nozzle.

### BRIEF DESCRIPTION OF THE DRAWINGS

The present invention will be better understood from reading the following description of non-limiting embodiments, with reference to the attached drawings, wherein below:

FIG. 1 is a schematic illustration of an extruder head or nozzle of an additive manufacturing system according to an embodiment of the present invention.

FIG. 2 is an enlarged, cross-sectional view of a portion of the extruder head of FIG. 1.

FIG. 3 is a schematic illustration of an extruder head or nozzle of an additive manufacturing system according to another embodiment of the present invention.

### DETAILED DESCRIPTION OF THE PREFERRED EMBODIMENTS

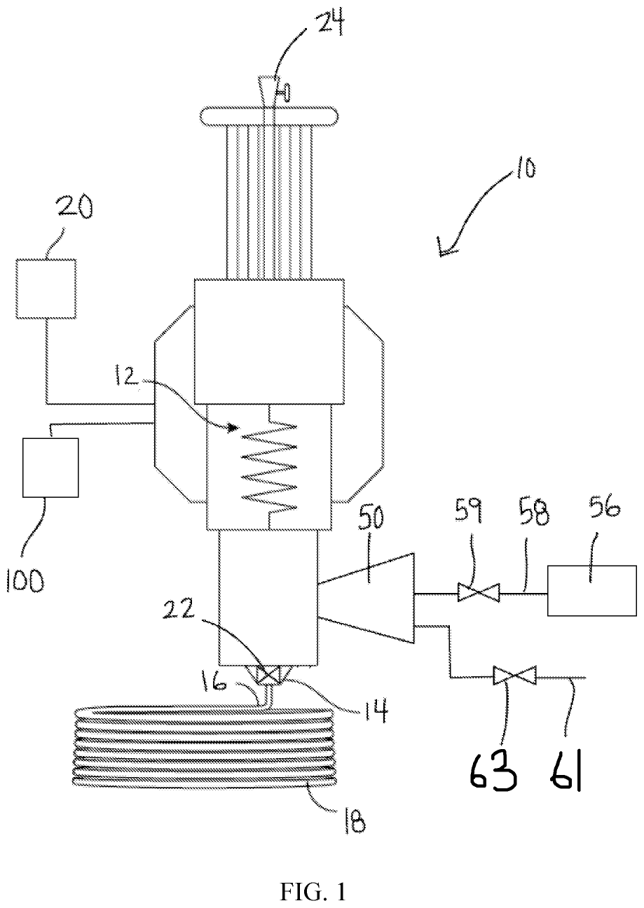

Referring now to FIG. 1, an extrusion head 10 (also referred to herein as print heat 10) of an additive manufacturing system according to an embodiment of the present invention is illustrated. As shown therein, the print head 10 includes a controllable heating element 12 and a nozzle 14. In an embodiment, the print head 10 is configured to receive a raw material in the form of a filament or granules, for example, which, in either case, are heated by the heating element 12 to produce a flowable extrudate that is output from the nozzle 14. That is, the flowable extrude exits the nozzle 14 in the form of a molten print material 16, which is controllably dispensed by the print head 10 to form an object 18, as known in the art. Alternatively, the print head 10 may receive the print material in an already molten or flowable state, in which case the heating element 12 may be utilized to further heat or maintain the material at a desired temperature just before exiting the nozzle 14. Accordingly, it is contemplated that the print head 10 disclosed herein may be utilized in a variety of additive manufacturing systems and processes, including FDM and FPF systems, as well as the system disclosed in U.S. patent application Ser. No. 17/024,794. In an embodiment, the raw material may be, for example, thermoplastics such as polyethylene (PE), polypropylene, acetal, acrylic, nylon (polyamides), polystyrene, polylactic acid (PLA), acrylonitrile butadiene styrene (ABS) and/or polycarbonate, although other materials known in the art may also be utilized without departing from the broader aspects of the invention

In an embodiment, the print head 10 is preferably integrated with, or connected to, a control and positioning system 20 for controlling a position of the print head 10 and nozzle 14 thereof with respect to a substrate or article support surface. In an embodiment, the control and positioning system may be a robotic arm or a CNC control system, although other control and positioning means known in the art may also be employed.

With further reference to FIG. 1, in an embodiment, the nozzle 14 includes a flow control valve 22 that is operable to selectively allow for, or prevent, the flowable extrudate from existing the nozzle 14. For example, the flow control valve 20 may be communicatively coupled to a controller 100 that is configured to control the print head 10 (including the heating element 12 and positioning system 20), and is movable between a closed or OFF position where flowable extrudate/print material is prevented from exiting the nozzle 15, and an open or ON position where flowable extrudate /print material can exit the nozzle 14, under control of the controller 100. In an embodiment, the flow control valve 22 may be positioned in one or more intermediate states between open and closed positions to aid in controlling a flow rate or cross-sectional area of the extrudate existing the nozzle 14. It is contemplated that any type of flow control valve known in the art may be employed. While FIG. 1 illustrates that the flow control valve 22 is positioned at the nozzle outlet, it is also contemplated that the flow control valve may be positioned further upstream from the nozzle 14, including within the print head 10, itself, at the inlet 24 of the print head 10, or even further upstream. In yet other embodiments, the nozzle 14 may be configured as a mechanical iris which is operable to selectively increase, decrease and/or close off the nozzle outlet.

Importantly, in operation, the flow control valve 22 may be moved to the closed position under control of the controller to shut off flow of flowable extrudate from the nozzle 14. This prevents drooling or stringing when moving the print head 10 from one location to another when forming an object. The flow control valve 22 can then simply be moved to the open position to resume printing. The use of the flow control valve 22 therefore increases the quality of additively manufactured parts by minimizing drooling and stringing, as well as obviating the need to employ post-printing processes such as post-production heating or machining to remove stringing.

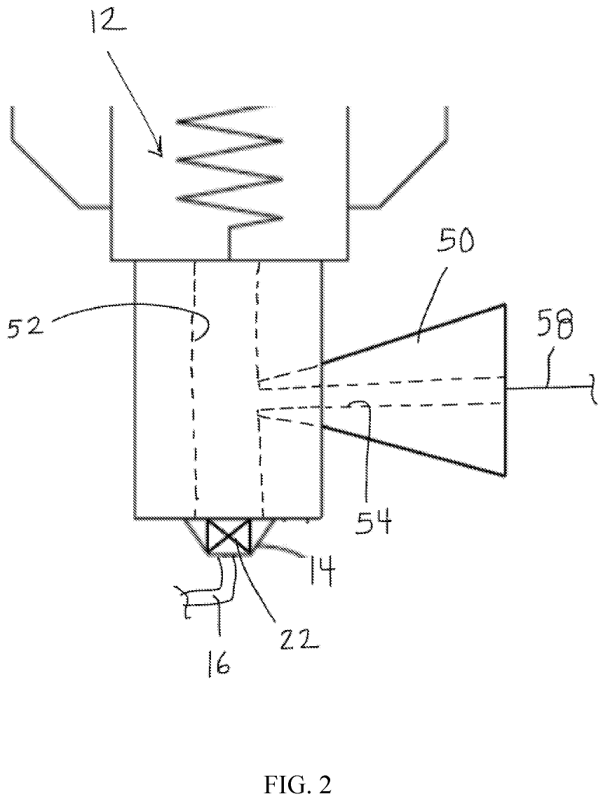

With further reference to FIG. 1, in an embodiment, the print head 10 may also include an additive injection device 50 that is configured to inject an additive into the flow of flowable extrudate just prior to the nozzle outlet. For example, as best shown in FIG. 2, the print head 10 includes a main passage 52 for the flow of flow of extrudate to the nozzle 14. The additive injection device 50 includes a passage 54 in fluid communication with the main passage 52 within the print head 10 so that an additive flowing through the passage 54 within the additive injection device 50 enters the main passage 52 and mixes with the extrudate therein. In an embodiment, the print head 10 may include a mixing device (not shown) intermediate the nozzle outlet and the point where the additive is injected into the main passage 52 to facilitate complete mixing of the additive with the extrudate prior to exiting the nozzle 14. It is contemplated that the mixing device may be a mechanical mixing device (including static or dynamic mechanical mixing devices). In other embodiments, the mixing device may be a specific passage configuration that generates turbulence or eddies (e.g., a venturi) within the passage so as to facilitate mixing of the additive and flowable extrudate.

Referring back to FIG. 1, the additive injection device 50 is fluidly connected to a supply 56 of additive via a flow line 58 having a flow control valve 59. The flow control valve 59 may be communicatively coupled to the controller 100 so that a position of the valve 59 may be controlled. One or more auxiliary additive flow lines 59 each having a control valve 61 may also be present so that various supplies of different additives can be connected to the device 50, as desired.

It is contemplated that a variety of additives may be mixed with the flowable extrudate within the print head 10 using the additive injection device 50. These may include, for example, a pigment or dye so that the color of the print material can be varied, a friction reducing additive such as graphite shavings or powder, a magnetic material such as beads or shavings to impart magnetic qualities to a printed object or portion thereof, an adhesive, a thermosetting material, a pressure sensitive adhesive, etc. Other additives that are capable of altering the characteristics (e.g., function, optical, tactile, etc.) of the print material 16 may be utilized.

While FIGS. 1 and 2 illustrate the additive injection device 50 and passage 54 thereof as being oriented generally perpendicular to the passage 52 within the print head 10, it is contemplated that the passage 54 may be oriented at other angles between 0 degrees and 180 degrees with respect to the passage 52. In an embodiment, the angle may be between 0 degrees and 90 degrees (with angles less than 90 degrees resulting in a flow out of the injection device 50 in a direction generally parallel to and the same as, i.e., not opposite to, the flow direction of print material 16 within the passage 52, and angles between 90 degrees and 180 degrees resulting in a flow out of the injection device 50 in a direction generally opposite to the flow direction of print material 16 within the passage 52). In an embodiment, the angle is preferably between about 0 degrees and about 45 degrees. In another embodiment, the angle is preferably between about 45 degrees and about 90 degrees. Moreover, while FIG. 2 illustrates a

In use, the additive injection device 50 may be utilized in conjunction with the print head 10 to impart different characteristics to different portions of the additively manufactured object 18. For example, a friction reducing additive may be mixed with the flowable extrudate when printing a portion of object 18 that will interface within another component. In such a case, the object 18 is printed according to a preprogrammed set of instructions stored in memory and accessed by the controller 100. When it comes time to print the interfacing part (e.g. a tab, pin, etc.), a graphite additive, for example, may be mixed with the flowable extrudate using the additive injection device 50 under control of the controller 100. This interfacing part, due to the presence of the graphite additive, may have a lower coefficient of friction, which may facilitate sliding together or relative movement between two interfacing parts. Similarly, if a strong connection between interfacing parts is desired, an adhesive, pressure sensitive adhesive, or thermosetting material, etc., may be added to the flowable extrudate using the additive injection device 50 when printing the interfacing portion of the object which will facilitate interconnection of the parts. In some embodiments, the additive may be mixed with the flowable extrudate only when forming an outermost layer of the interfacing portion of the object. The additive injection device 50 thus allows additives to be added to the print material 16 as an inline part of the additive manufacturing process, without pausing or stopping the build process and without requiring any material changeover.

In an embodiment, a pigment may be added as an inline part of the additive manufacturing process without stopping or pausing the printing process. For example, when it is desired to form a portion of an object with the desired color, the controller 100 opens the valve 59 to initiate a flow of the pigment from the supply 56, through the channel 54, into the main channel 52 where it is mixed with the flowable extrudate; the pigmented extrudate then exits the nozzle 14 to form the object 18. This is in contrast to existing systems where printing must be paused, the system purged, and a filament or granules of the desired color fed into the system. This entire process must be repeated every time a color changeover is desired. With the present invention, the addition of pigment can simply be stopped by controlling the valve 59 to the closed position, eliminating the purging step and requiring no changeover to a different material.

Importantly, the print head 10 and additive injection device 50 of the present invention can be utilized to only add color to discrete and precise portions of a printed object such as, for example, to the outermost bead/layer and/or viewable portion of an object (e.g., only the portions of the object that will be visible). This results in a substantial reduction in the amount of pigment needed and/or utilized, thus realizing significant cost savings.

In yet other embodiments, the additive may be a gas such as, for example, nitrogen, that may be utilized to produce an extrudate/print material having foam-like properties. The ability to produce a foam-like extrudate may be desirable in controlling the thickness or height of the bead produced, and can be used when printing a support structure for an overhanging or cantilevered portion of an object. In particular, certain objects have overhanging portions which must be supported by a support structure during printing and prior to curing/hardening. With existing systems, the support structure can be printed using the same print material (whereby the support structure is snapped off or machined away after printing is complete). This can result in substantial material waste, however. Adding a gas to the flowable extrudate to produce a foam-like print material can substantially reduce the amount of polymer utilized. For example, when printing the support structure, a gas such as nitrogen may be mixed with the print material using additive injection device 50 to create a foam. The support structure, only, may be printed with this foam-like print material, resulting in much less polymer used. After printing, the foam like support structure can more easily be snapped or broken off from the finished part.

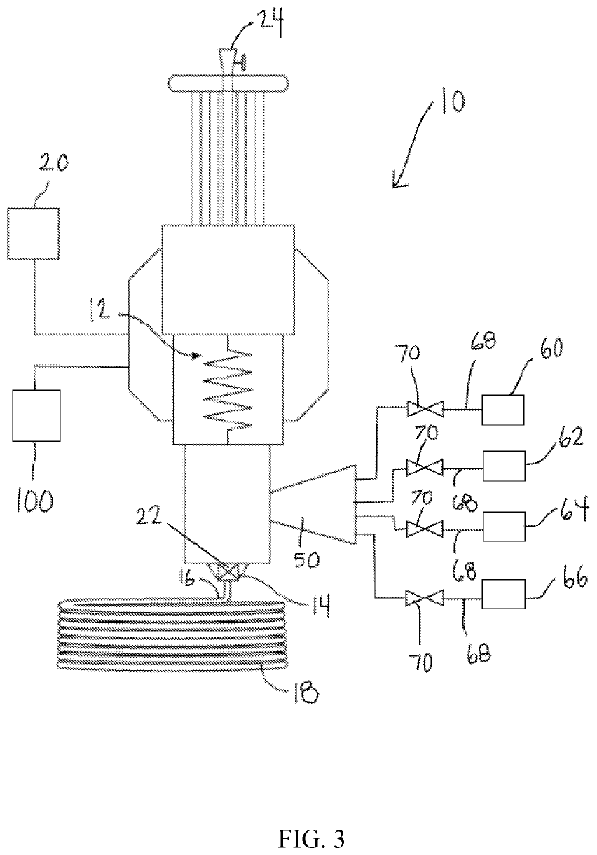

As indicated above, the additive injection device 50 may be utilized to selectively add a pigment to the print material as an inline part of the additive manufacturing process. With reference to FIG. 3, in an embodiment, the additive injection device 50 may be configured as a pigmentation system. In such embodiment, the additive injection device 50 may be fluidly connected to a supply 60 of magenta pigment, a supply 62 of yellow pigment, a supply 64 of cyan pigment, and in some embodiments, a supply 66 of black pigment via a respective flow line 68 each having a flow control valve 70. The controller 100 may be configured to selectively control the addition of pigment from the various supplies 60, 62, 64, 66 to the flowable extrudate within the nozzle head 16 to produce a print material of almost any color desired. The color of the bead exiting the nozzle 14 can be changed in real time simply by controlling the flow of pigment from the reservoirs/sources 60, 62, 64, 66. In an embodiment, the additive injection device 50 may include a mixing system of any type known in the art (e.g., mechanical (static or dynamic), venturi, etc.) so that the various additives (e.g., different pigments) may be mixed before contacting the print material 16 within the print head 10.

In an embodiment, the additive injection device 50 maybe utilized in combination with the flow control valve 22 of the nozzle 14 so that the output of print material with a desired additive can be precisely controlled.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A system for additive manufacturing, comprising:
a print head having a nozzle configured to output a flowable extrudate to form an article; and
an additive injection device configured to add an additive to the flowable extrudate prior to exiting the nozzle.

2. The system of claim 1, further comprising:
an extrusion apparatus in fluid communication with the print head, the extrusion apparatus configured to receive a raw material and to output a flowable extrudate to the print head.

3. The system of claim 2, further comprising:
a heated conduit in fluid communication with an outlet of the extrusion apparatus and an inlet of the print head, the heated conduit being configured to maintain the flowable extrudate in a flowable state and to convey the flowable extrudate from the extrusion apparatus to the print head.

4. The system of claim 1, wherein:
the print head is configured to receive a raw material in the form of a filament or granules.

5. The system of claim 4, wherein:
the print head includes a heating element configured to produce the flowable extrudate from the filament or granules.

6. The system of claim 1, wherein:
the additive is at least one of a pigment, a friction reducing additive, an adhesive, a pressure sensitive adhesive, a thermosetting material and/or a gas.

7. The system of claim 1, wherein:
the print head includes a flow control valve associated with the nozzle for selectively controlling a flow of the flowable extrudate from the nozzle.

8. The system of claim 1, wherein:
the additive injection devices includes a plurality of flow lines, each flow line being configured for connection to a respective additive supply;
wherein each flow line includes a respective flow control valve.

9. The system of claim 8, wherein:
the plurality of flow lines include at least a first flow line configured to receive a magenta pigment, a second flow line configured to receive a yellow pigment, and a third flow line configured to receive a cyan pigment.

10. A method of additive manufacturing, comprising the steps of:
moving a print head and outputting a flowable print material according to set of instructions executed by a controller, to form an article; and
within the print head, mixing an additive with the flowable print material to alter a characteristic of the flowable print material.

11. The method according to claim 10, wherein:
the step of mixing the additive with the flowable print material is carried out as an in-line part of the additive manufacturing process, without pausing or ceasing a flow of the flowable print material out of a nozzle of the print head.

12. The method according to claim 10, wherein:
the additive is a pigment.

13. The method according to claim 10, wherein:
the additive is a friction reducing additive.

14. The method according to claim 10, wherein:
the additive is a gas.

15. The method according to claim 10, wherein:
the additive is an adhesive, a pressure sensitive adhesive or a thermosetting material.

16. The method according to claim 14, further comprising the step of:
forming a first portion of the article from the flowable print material;
wherein the step of mixing the gas with the flowable print material includes forms a foam-like print material;
wherein the method further includes forming a second portion of an article from the foam-like print material and, subsequent to forming the second portion of the article, ceasing the mixing of the additive with the flowable print material and forming a third portion of the article from the flowable print material.

17. The method according to claim 16, wherein:
the second portion of the article is a support structure of the article used to support the third portion of the article during the additive manufacturing process; and
wherein the method further includes the step of removing the support structure from the third portion of the article.

18. The method according to claim 10, wherein:
the additive is one of a friction-reducing additive and an adhesive;
wherein the method further includes the step of forming an interfacing portion of the article with the print material mixed with the additive.

19. The method according to claim 10, wherein:
the additive is a pigment; and
wherein the step of mixing the additive with the flowable print material forms a pigmented print material;
wherein the method further includes the step of forming only an outermost layer or bead of the article with the pigmented print material.

20. A system for additive manufacturing, comprising:
a print head having a nozzle configured to output a print material to form an article, and a flow control valve configured to selectively control a flow of the print material from the nozzle;
a control and positioning system configured to control movement of the print head according to a preprogrammed set of instructions; and
an additive injection device configured to add an additive to the print material prior to exiting the nozzle to alter a characteristic of the print material, the additive injection device having a flow control valve configured to selectively control a flow of the additive into the nozzle.
